(19) United States
(12) Patent Application Publication
(10) Pub. No.: US 2009/0021542 A1
(43) Pub. Date: Jan. 22, 2009

(54) System and method for fluid transmission and temperature regulation in an inkjet printing system

(76) Inventors: Dan E. Kanfoush, Niagara Falls, NY (US); Anthony V. Moscato, North Tonawanda, NY (US)

Correspondence Address: MCCRACKEN & FRANK LLP, 311 S. WACKER DRIVE, SUITE 2500, CHICAGO, IL, 60606, US

(21) Appl. No.: 12/215,654

(22) Filed: Jun. 27, 2008

Related U.S. Application Data
(60) Provisional application No. 60/937,785, filed on Jun. 29, 2007.

(51) Int. Cl. B41J 29/38

(52) U.S. Cl. 347/6; 347/17

(57) ABSTRACT

A system for fluid transmission and temperature regulation in an inkjet printing system comprises first and second ink supplies connected via respective first and second valves to an inlet end of a fluid supply conduit. A printhead mount includes an inlet port connected to an outlet end of the fluid supply conduit and an outlet port connected via a first fluid transmission conduit and a third valve to a waste reservoir. A printhead cartridge is mounted within the printhead mount and in fluid communication with the inlet and outlet ports of the printhead mount. A temperature control element and a temperature sensor are each disposed downstream of the first and second valves, and a controller is connected to the temperature control element, the temperature sensor, and to each of the first, second, and third valves.

### CROSS REFERENCE TO RELATED APPLICATIONS

This application claims the benefit of U.S. Provisional Application Ser. No. 60/937,785, filed Jun. 29, 2007, and incorporated by reference herein in its entirety.

### REFERENCE REGARDING FEDERALLY SPONSORED RESEARCH OR DEVELOPMENT

Not applicable

### SEQUENTIAL LISTING

Not applicable

### BACKGROUND OF THE INVENTION

1. Field of the Invention

The present disclosure relates to fluid systems and, more specifically, to systems and methods for the control and transmission of fluids in inkjet printing systems.

2. Description of the Background of the Disclosure

An inkjet printing system conventionally includes one or more printheads, one or more ink supplies, and an electronic controller to regulate the flow of ink through the printing system. Ink is typically passed, in the form of tiny droplets, through a plurality of independently addressable nozzles in a printhead and toward a print medium, so as to make contact with the print medium in the configuration desired. Commonly, printheads and their associated nozzles are configured in an array or arrays to properly sequence ink ejection from the nozzles. As the printheads and/or the print medium are moved relative to one another, images are formed from the ink transferred to the print medium.

In one inkjet printing system arrangement, a plurality of printheads is arranged in a staggered configuration to form a printhead array spanning a nominal page width of the print medium. The print medium is advanced during the printing process; the printhead array is fixed relative to the print medium. Such inkjet printing system arrangements may be used for high-volume printing requiring high speeds and precision in ink placement.

Debris, such as dried ink, dust and print medium fibers, can collect on printhead surfaces, clogging nozzles and preventing proper ink ejection therefrom, and can also become lodged within fluid transmission passages used to deliver and collect ink and other fluids used within inkjet printing systems. Additionally, if an inkjet printing system is not used for a sufficient period of time, the fluid transmission passages and printheads tend to accumulate encrustations of dried ink or other fluids which may obstruct or interfere with the flow of fluids within the transmission passages. If such debris is allowed to accumulate, deterioration in print quality will occur, and an inkjet printing system may be damaged by the restricted flow of fluids. Keeping the printheads and fluid transmission passages free of ink and debris is imperative to efficient and proper operation of the inkjet printing system.

Generally, the printheads, nozzles, fluid transmission passages and ink supply reservoirs of an inkjet printing system are packaged into a plurality of printhead cartridges. However, various configurations of these elements are possible and may include carriage assemblies or mounts for the printheads and/or cartridges, extended external fluid transmission passages, and multiple ink and fluid reservoirs. Multiple reservoirs may be utilized to regulate the supply of fluids through the fluid transmission passages and to and from the printheads and associated nozzles for supplying ink to and cleaning of the inkjet printing system.

Conventional techniques to clean the inkjet printing system include scraping of the printheads, vacuuming and/or flushing of the fluid transmission passages and/or printheads, and absorbing printing system fluids before they are allowed to dry, among others. Some inkjet printing systems may also utilize a combination of these and other cleaning techniques to accomplish a thorough decontamination of the printing system. In conventional inkjet printing systems, the printheads and associated nozzles are installed in the inkjet printing system during the flushing, cleaning or other actions undertaken during the inkjet printing system's fluid supply and cleaning cycles.

To prevent additional damage to the printheads, nozzles and fluid transmission passages, it is also desirable to maintain the fluids within an inkjet printing system within a predetermined acceptable temperature range. Temperature control of the fluids within an inkjet printing system may aid in protection and extended life of the printheads and nozzles, improve speed of printing and allow for consistent color output and performance in otherwise uncontrolled environments external to the printing system. Heat generating elements are typically used adjacent to or near the printheads and associated nozzles, often together with temperature sensors, to control the temperature of the fluids in the printing system, as needed.

It can be appreciated, then, that a system may be provided which controls fluid transmission and regulates fluid temperature throughout an inkjet printing system to achieve a cleaning of the fluid transmission passages and system components within and provide for optimum performance of the inkjet printing system as a whole.

### SUMMARY OF THE INVENTION

According to one aspect of the invention, a system for fluid transmission and temperature regulation in an inkjet printing system comprises first and second ink supplies connected via respective first and second valves to a fluid supply conduit. A printhead mount is adapted to hold a printhead cartridge and includes an inlet port connected to the fluid supply conduit and an outlet port connected via a fluid transmission conduit and a third valve to a waste reservoir. A controller is connected to each of the first, second, and third valves.

According to another aspect of the invention, a method for fluid transmission and temperature regulation in an inkjet printing system that includes a printhead mount that is adapted to hold a printhead cartridge and further includes an inlet port connected to a fluid supply conduit that is supplied by first and second ink supplies connected via respective first and second valves to the fluid supply conduit and an outlet port connected via a fluid transmission conduit and a third valve to a waste reservoir, comprises the steps of removing a first printhead cartridge from the printhead mount and closing the first valve. The method further comprises the steps of opening the third valve, opening the second valve, and allowing a first predetermined time period to pass, wherein the first predetermined time period is sufficient to allow ink from the second ink supply to flow beyond the third valve. The method further comprises closing the third valve and inserting a second printhead cartridge into the printhead mount.

According to a further aspect of the invention, a system for fluid transmission and temperature regulation in an inkjet printing system comprises first and second ink supplies connected via respective first and second valves to an inlet end of a fluid supply conduit. A printhead mount includes an inlet port connected to an outlet end of the fluid supply conduit and an outlet port connected via a first fluid transmission conduit and a third valve to a waste reservoir. A printhead cartridge is mounted within the printhead mount and in fluid communication with the inlet and outlet ports of the printhead mount. A temperature control element and a temperature sensor are each disposed downstream of the first and second valves, and a controller is connected to the temperature control element, the temperature sensor, and to each of the first, second, and third valves.

According to yet another aspect of the invention, a method for fluid transmission and temperature regulation in an inkjet printing system includes a first printhead cartridge mounted within a printhead mount and in fluid communication with inlet and outlet ports of the printhead mount. The inlet port is connected to an outlet end of a fluid supply conduit that is supplied by first and second ink supplies connected via respective first and second valves to an inlet end of the fluid supply conduit. The outlet port is connected via a first fluid transmission conduit and a third valve to a waste reservoir. The method comprises the steps of removing the first printhead cartridge from the printhead mount, closing the first valve, opening the third valve, opening the second valve, and allowing a first predetermined time period to pass, wherein the first predetermined time period is sufficient to allow ink from the second ink supply to flow beyond the third valve. The method further comprises the steps of closing the third valve, inserting a second printhead cartridge into the printhead mount, and operating the inkjet printing system with the ink from the second ink supply. The method further comprises the steps of determining a temperature of the ink from the second ink supply from a temperature sensor disposed within the second printhead cartridge, comparing the temperature of the ink from the second ink supply to a first predetermined temperature range and, if necessary, activating a temperature control element disposed upstream of the temperature sensor disposed within the second printhead cartridge to correct the temperature of the ink from the second ink supply to within the first predetermined temperature range.

### BRIEF DESCRIPTION OF THE DRAWINGS

FIG. 1 is a schematic illustration of a fluid control system for an inkjet printing system according to an embodiment of the present disclosure;

FIG. 2 is a schematic illustration of a fluid control system for an inkjet printing system according to another embodiment of the present disclosure;

FIG. 3 is a schematic illustration of one embodiment of a fluid pressurization system utilized in one embodiment of the present disclosure;

FIG. 4 is a perspective view of a printhead mount according to one embodiment of the present disclosure;

FIG. 5 is a cross-sectional view taken along line 5-5 of FIG. 4;

FIG. 6 is a cross-sectional view taken along line 5-5 of FIG. 4, showing an embodiment of temperature regulation elements;

FIG. 7 is a schematic illustration showing another embodiment of temperature regulation elements;

FIG. 8 is a flow chart illustrating an embodiment of the operation of the fluid control system of FIG. 1;

FIG. 9A is a flow chart illustrating an embodiment of the operation of the fluid control system of FIG. 2;

FIG. 9B is a flow chart illustrating another embodiment of the operation of the fluid control system of FIG. 2;

FIG. 10 is a flow chart illustrating an embodiment of the operation of temperature regulation elements;

FIG. 11 is a schematic illustration of a fluid control system for an inkjet printing system according to a further embodiment of the present disclosure; and

FIG. 12 is a schematic illustration of a fluid control system for an inkjet printing system according to a still further embodiment of the present disclosure.

### DETAILED DESCRIPTION OF THE DISCLOSURE

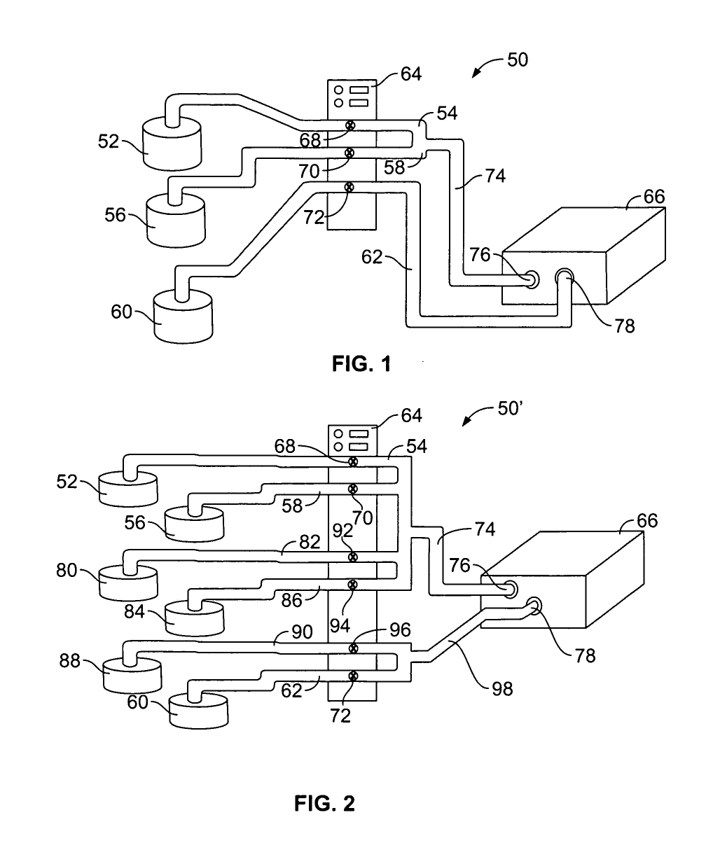

Referring now to the drawings, FIGS. 1 and 2 generally illustrate fluid control systems 50 and 50′ for the transmission of various fluids to and from a printhead mount 66. Inkjet printing systems using fluid control elements may vary in scope: printing systems may include one printhead with a corresponding printhead mount, or may be made more complex to include multiple printing arrays, each containing a plurality of printheads and mounts. As such, the fluid control systems 50 and 50′ described herein are scalable according to the complexity and intricacy of the inkjet printing system desired. Having the fluid control systems 50, 50′ connected to the printhead mount 66 in place in a printing system allows the printhead mount to be flushed and/or cleaned without removal of the printhead mount 66 from the printing system, which may allow for savings in time spent on manual labor in removing and returning the printhead mount 66 to the printing system. Flushing the printhead mount 66 in place may also limit operator interaction with components of the fluid control system 50, 50′, which may limit possible damage to the components or errors that may occur in a subsequent realignment of the printhead mount 66 when it is returned to the printing system.

In the embodiment of FIG. 1, the fluid control system 50 includes a first ink reservoir 52 and a second ink reservoir 56. The second ink reservoir 56 preferably may contain ink of a different color than the first ink reservoir 52. Both the first and second ink reservoirs 52, 56 are connected to an inlet 76 of the printhead mount 66 through a fluid transmission conduit 74. Each of the fluid transmission conduits described herein may be tubes, pipes, hoses, or any other conduit, flexible or rigid, capable of carrying a fluid, as is known in the art. The fluid transmission conduit 74 is a manifolded conduit which connects fluid transmission conduits 54 and 58. The conduit 54 is connected, in turn, to the first ink reservoir 52; the conduit 58 is connected to the second ink reservoir 56. Valves 68, 70 are disposed along the conduits 54, 58, respectively, for regulating the flow of fluids along the conduits 54, 58. A controller 64 is electrically connected to and controls operation of the valves 68, 70, as well as a plurality of other valves yet to be described. A fluid transmission conduit 62 connects an outlet 78 of the printhead mount 66 to a waste reservoir 60. A valve 72 is disposed along the conduit 62, in much the same way the valves 68, 70 are disposed along the conduits 54, 58. The controller 64 is also electrically connected to and controls the operation of the valve 72. Each of the valves 68, 70 and 72, as well as the plurality of other valves described below, may be an electrically controlled solenoid valve or any other suitable valve able to be disposed within a fluid transmission conduit. The controller 64 may be an electronic device such as a computer or microprocessor that is responsive to a real-time clock and other inputs, controlling the opening and closing of the valves in the fluid control systems 50 or 50′ in accordance with the methods described herein.

In another embodiment, shown in FIG. 2, a fluid control system 50′ includes, in addition to the elements described above with regard to FIG. 1, first and second fluid reservoirs 80, 84 connected to the printhead mount inlet 76 through the fluid transmission conduit 74. The first and second fluid reservoirs 80, 84 may contain fluids such as air (or other gases such as helium, argon, nitrogen, oxygen, etc.), water, surfactants, solvents, water-displacing agents, humectants, or combinations of any or all of these chemicals that may be advantageous to cleaning or maintaining the functionality and viability of the fluid control system 50′. In one embodiment, one or both of the first and second reservoirs may contain a combination of about 0.4% surfactant, such as a surfactant sold by Air Products under the trademark name Surfynol®, in deionized water. Fluid transmission conduits 82, 86 for the first and second fluid reservoirs 80, 84, respectively, are also shown in FIG. 2 and are further manifolded into the conduit 74. A valve 92 is disposed along the conduit 82, and a valve 94 is disposed along the conduit 86; each of the valves 92, 94 regulate fluids along the conduits 82, 86. The controller 64 also electrically connects to and controls the operation of the valves 92, 94.

In the embodiment of FIG. 2, the fluid transmission conduit 62 is manifolded with an additional fluid transmission conduit 90 at one end of a fluid transmission conduit 98. The other end of the conduit 98 connects to the printhead mount outlet 78. A recycle reservoir 88 is connected to the conduit 90, with a valve 96, electrically connected to and controlled by the controller 64, disposed along the conduit 90. The recycle reservoir 88 may be used to accept viable ink or fluids passed through the fluid control system 50′ during a cleaning cycle of the fluid transmission conduits.

It can be appreciated that any number of additional ink or fluid reservoirs may be connected to the fluid control systems 50 or 50′. Each additional ink reservoir may contain a unique color of ink and may be connected to the fluid control systems 50 or 50′ through additional fluid transmission conduits and controlled valves. Each additional fluid reservoir may contain a different or similar fluid to aid in the flushing and cleaning of the fluid control systems 50 or 50′ and may also connect to the systems by way of additional conduits and valves. The function and operation of the fluid control systems 50, 50′ will be described in more detail below.

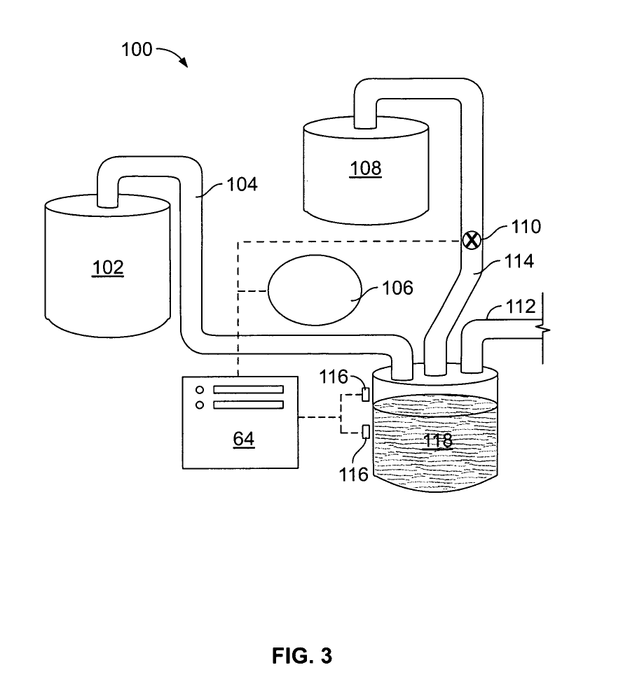

Turning to FIG. 3, a fluid pressurization system 100 is illustrated. Such a system may be connected to and utilized as part of the fluid control system 50 or 50′, where a pressurizing reservoir 118 is any one of reservoirs 52, 56, 80, 84, or additional reservoirs, and where a fluid supply conduit 112 is any one of the conduits 54, 58, 82, 86, or additional conduits. In the pressurization system 100, a fluid reservoir 102 connects to the pressurizing reservoir 118, with a pump 106 disposed along a connecting fluid supply conduit 104. Another reservoir of compressed fluid 108 is joined to the pressurized reservoir 118 through a fluid supply conduit 114, with a valve 110 disposed along the conduit 114. The controller 64 is also connected to and controls elements in the fluid pressurization system 100—the pump 106, the valve 110, and fluid level sensors 116, which can electrically detect the fluid level in the pressurizing reservoir 118.

In operation, the controller 64 operates the pump 106 to pull fluid in reservoir 102 through the conduit 104, through the pump 106, and into the pressurizing reservoir 118. The controller 64 then opens the valve 110 to allow the compressed fluid 108 to flow through the conduit 114 and into the pressurizing reservoir 118, causing the fluid inside the reservoir 118 to become pressurized to a pressure above the ambient pressure. The above-described operation is regulated by level sensors 116 which may provide feedback to the controller 64 to allow the reservoir 118 to fill to a predetermined optimum level of fluid from the reservoir 102. As valves in the fluid control systems 50 or 50′ are opened, the fluids within the reservoir 118 will be drawn through the conduit 112 to a lower pressurized environment along the fluid transmission conduits of the fluid control systems 50 or 50′.

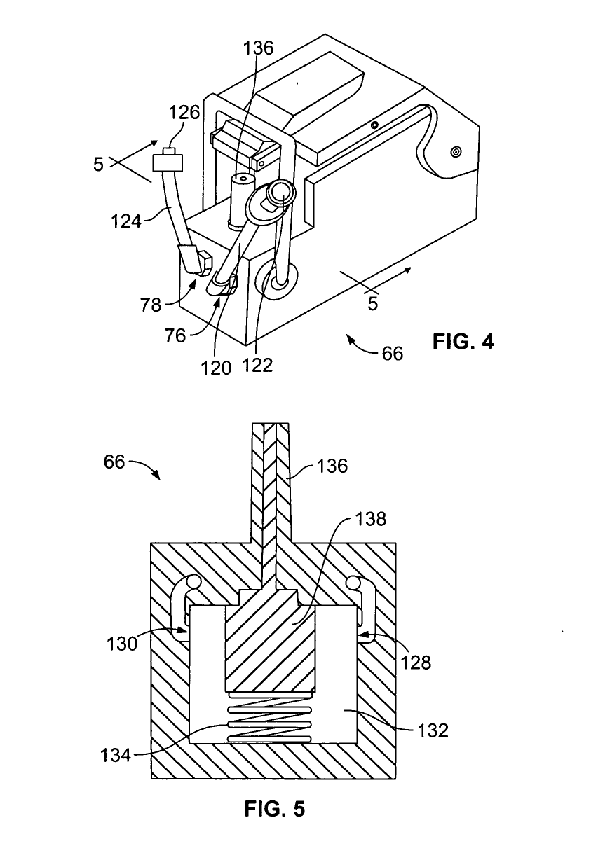

In FIG. 4, one embodiment of the printhead mount 66 is shown in perspective. A printhead cartridge (not shown) which may hold nozzles, fluid transmission passages and a secondary ink reservoir may be placed inside the printhead mount 66 and secured into place in a variety of ways, including the use of a crossbar and hook, as shown in FIG. 4. The printhead mount inlet 76 and outlet 78 are shown connected to an inlet tube 120 with an adapter 122 and an outlet tube 124 with an adapter 126, respectively. Such tubes 120, 124 and adapters 122, 126, or other suitable connectors, may be utilized in the fluid control systems 50 or 50′ to connect the printhead mount 66 to the fluid transmission conduits. In the fluid control system 50, the adapter 122 connects to the manifolded conduit 74; the adapter 126 connects to the conduit 62. In the fluid control system 50′, the adapter 122 also connects to the manifolded conduit 74; however, the adapter 126 connects to the manifolded conduit 98.

FIG. 5 is a cross-section of the embodiment of the printhead mount 66 of FIG. 4, showing one embodiment of the printhead mount 66 and a valve cavity 132. The valve cavity 132 includes an inlet port 128 in fluid communication with the inlet 76 and an outlet port 130 in fluid communication with the outlet 78. A plunger 138 within the valve cavity 132 is mounted atop a spring 134 on one end, while the other end of the plunger 138 extends into an ink snout 136. During printing operations, when a printhead cartridge (not shown) is installed in the printhead mount 66, the spring 134 is compressed and causes the plunger 138 to be forced downward through the ink snout 136, opening a passage within the valve cavity 132 to transmit fluids from the cavity 132 to the printhead cartridge through the ink snout 136. Thus, when a printhead cartridge is installed in the printhead mount 66, the printhead cartridge is in fluid communication with the inlet 76 and the outlet 78 via the ink snout 136. When the printhead cartridge (not shown) is removed from the printhead mount 66, the spring 134 biases the plunger 138 upwards to close the ink snout 136 to fluids.

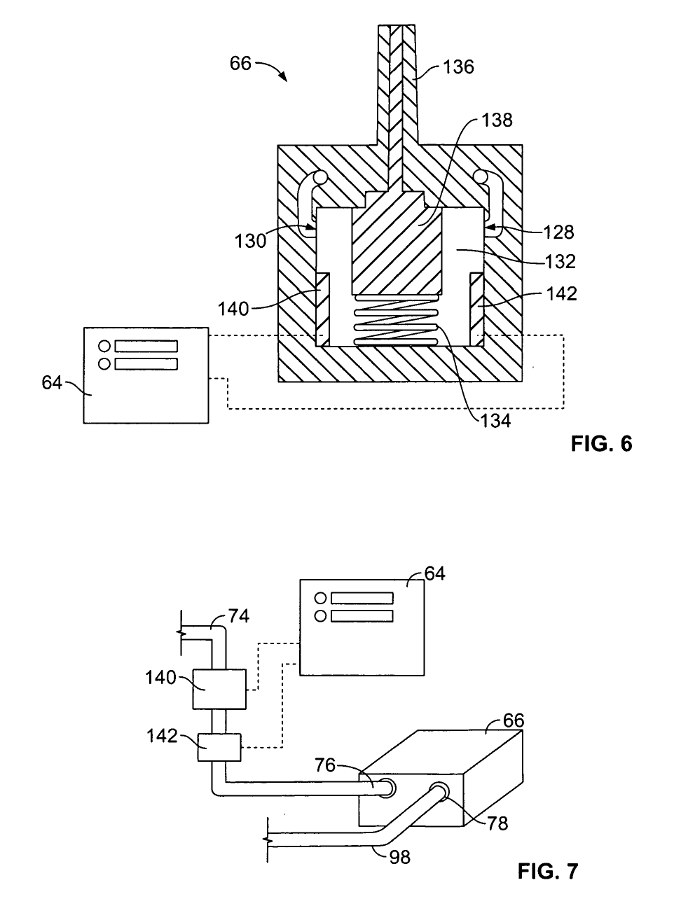

Referring to FIGS. 6 and 7, multiple techniques of temperature regulation for the fluid control systems 50 or 50′ may be provided, including the use of a temperature control element 140, for example, a heating element, a cooling element, or a combination heating and cooling element, connected to the controller 64 which sits adjacent to or contacts one or multiple fluid transmission conduits and/or the printhead mount 66, transmitting heat to or dissipating heat from fluid control system elements. Multiple, independent heating and/or cooling elements (not shown) may also be utilized which are connected to, and controlled separately by, the controller 64. A temperature sensor or sensors 142 may be located among the elements of the fluid control systems 50 or 50′, with feedback provided to the controller 64, to sense and report the temperature at various locations within the fluid control systems 50 or 50′.

In the embodiment of FIG. 6, a temperature control element 140 is associated with the valve cavity 132, with a connection through the printhead mount 66 to the controller 64 for operative control. A temperature sensor 142 for feedback of fluid temperature is also associated with the valve cavity 132, having connection to the controller 64 for feedback purposes. In FIG. 7, the temperature control element 140 is disposed serially along the fluid transmission conduit 74 with the temperature sensor 142; control lines to both the temperature control element 140 and the temperature sensor 142 connect to the controller 64 for operation and feedback.

When an inkjet printing system has sustained printing operations for a period of time, it may be desirable to change the ink being supplied to a specific printhead mount 66 or multiple printhead mounts 66 to ink of a different type or color. It may also be desirable to first flush the fluid transmission conduits, reservoirs, and/or the printhead mounts 66 to clear out debris, ink and/or other fluids that may be contained within the elements of the fluid control systems 50 or 50′.

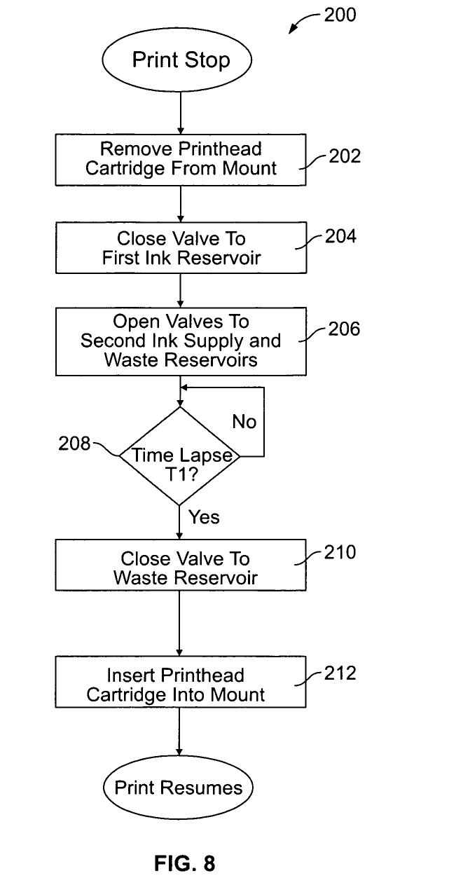

The operation shown in FIG. 8 illustrates one embodiment of a method 200 of transmitting fluid through the fluid control system 50 that is illustrated in FIG. 1. First, printing operations of an inkjet printing system are brought to a stop. Then, each printhead cartridge is removed from its respective printhead mount 66, as described in step 202. Next, at step 204, the controller 64 operates to close the valve 68 disposed along the conduit 54 connected to the first ink reservoir 52. At step 206, the controller 64 operates to open the valve 70 disposed along the conduit 58 and which is connected to the second ink reservoir 56. With the opening of the valve 70, ink is allowed to flow along the conduit 58, through the manifolded conduit 74 and to the printhead mount inlet 76, through the inlet port 128 and into the valve cavity 132. Also at step 206, the controller 64 operates to open the valve 72 along the conduit 62, which is in fluid communication with the waste reservoir 60. As ink is transmitted through the valve cavity 132, it is forced out of the printhead mount 66 at the outlet port 130, through the printhead mount outlet 78 and along the conduit 62 into the waste reservoir 60.

At step 208, in one embodiment, a predetermined time interval passes to allow for the fluid control system 50 to operate to supply ink from the second ink reservoir 56 to the printhead mount 66 and continuing to the waste reservoir 60, flushing the printhead mount 66 and the conduits 58, 74, and 62 of excess ink from the first ink reservoir 52. In another embodiment, a predetermined time interval is sufficient to allow ink from the second ink reservoir 56 to flow beyond the valve 72. In other embodiments, the time of the ink transmission may be assessed by a sensor, such as a rotational encoder, where the time interval may be measured as a predetermined pulse count generated by the rotational encoder as it measures fluid flow. If the assessed time interval has not occurred, the method 200 continues to return to step 208. When, however, the assessed time interval has occurred, the method 200 proceeds to step 210.

At step 210, with the desired ink transition having occurred, the controller 64 acts to close the valve 72 and ink transmission to the waste reservoir 60 is stopped. It is at step 212 that a printhead cartridge is inserted into the printhead mount 66, allowing fluid communication from the mount 66 to a printhead cartridge, as described above. Preferably, a printhead cartridge inserted into the printhead mount 66 is a new cartridge devoid of ink, a new cartridge having the same ink as has been supplied to the printhead mount 66 by the second ink reservoir 56, or a previously used cartridge that has been thoroughly cleaned and is ready to accept new ink to be used in continued printing operations. After a printhead cartridge is installed, printing operations of the inkjet printing system are allowed to resume.

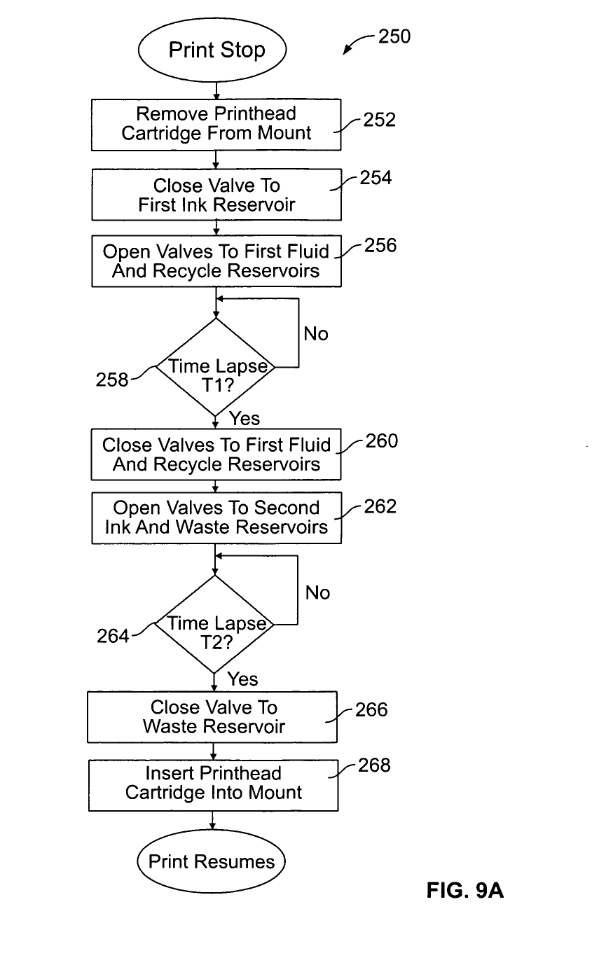

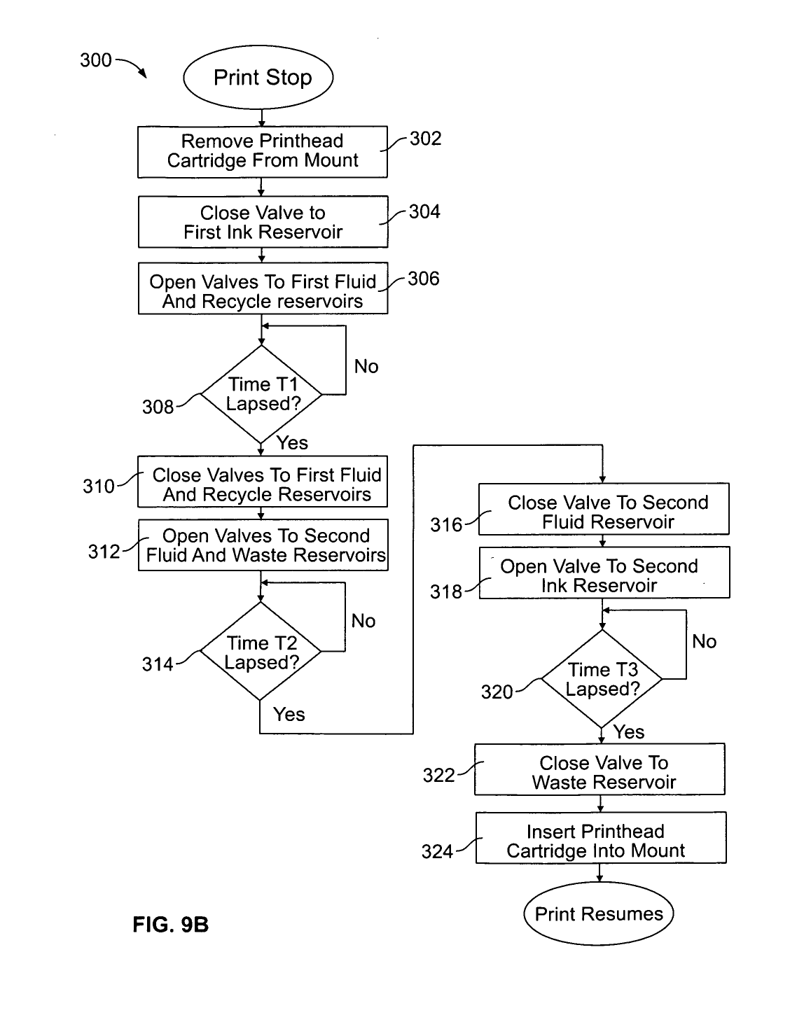

FIG. 9A illustrates one embodiment of a method 250 of transmitting fluid through the fluid control system 50′ that is illustrated in FIG. 2. Similar to the method 200 above, printing operations of an inkjet printing system are stopped and each printhead cartridge is removed from its respective printhead mount 66, as described in step 252. Again, as in the method 200, after a printhead cartridge is removed from the printhead mount 66, at step 254, the controller 64 operates to close the valve 68 disposed along the conduit 54 which is connected to the first ink reservoir 52. At step 256, the controller 64 acts to open the valve 92 disposed along the conduit 82, and which is connected to the first fluid reservoir 80. As the valve 92 is opened, fluid from the first fluid reservoir 80 is allowed to flow along the conduit 82, through the manifolded conduit 74 and to the printhead mount inlet 76, through the inlet port 128, and into the valve cavity 132. In conjunction, the controller 64 operates to open the valve 96 along the conduit 90, which is in fluid communication with the recycle reservoir 88. Remaining ink from the first ink reservoir 52 may be flushed out of the control system 50′ by the fluid from the first fluid reservoir 80, following a path to lower pressure, through the manifolded conduit 98, through the conduit 90, and into the recycle reservoir 88.

In one embodiment, a predetermined time interval may be assessed at step 258 to allow the fluid from the first fluid reservoir 80 to flow along the above-described path to at least past the valve 96 before the controller 64 effects a closure of the valve 96 connecting the recycle reservoir 88 to the fluid flow path at step 260. Also, the controller 64 acts to close the valve 92, stopping the flow of fluid from the first fluid reservoir 80. Other embodiments may utilize a sensor to determine the time interval to be assessed at step 258. The interval described at step 258 may be determined, for example, to allow for the recycle reservoir 88 to collect any remaining viable ink from the first ink reservoir 52 which may be reused in printing operations or elsewhere, avoiding the collection of fluids contaminated or diluted with the fluid emanating from the first fluid reservoir 80. Once the time interval at step 258 is assessed, the valves 92 and 96 are closed.

In this embodiment, the fluid control system may be sufficiently clear as to allow ink from the second ink reservoir 56 to flow into the conduits of the fluid control system 50′ and fill the printhead mount 66. The valves 70 and 72 are opened at step 262 and ink from the second ink reservoir 56 is allowed to flow into the conduit 58, through the manifolded conduit 74, into the inlet 76, through the inlet port 128, into the valve cavity 132 of the printhead mount 66. The ink from the second ink reservoir 56 may flow through the outlet port 130, out of the outlet 78, and through the conduit 90. The ink from the second ink reservoir 56 flows for an assessed time interval at step 264, where the time interval may be determined, for example, to allow the ink from the second ink reservoir 56 to reach at least downstream of the valve 72. The valve 72 is closed at step 266 and a printhead cartridge is inserted into the printhead mount 66 at step 268, allowing fluid communication between the printhead mount 66 and a cartridge, as described previously. A printhead cartridge used in the method 250 is preferably also of the type described in the method 200. After a printhead cartridge is installed, printing operations of the inkjet printing system are allowed to resume.

FIG. 9B illustrates another embodiment of a method 300 of transmitting fluid through the fluid control system 50′ that is illustrated in FIG. 2. This embodiment includes steps that are identical to the embodiment described hereinabove with regard to FIG. 9A, for example, steps 302 to 310 of the present embodiment are identical with steps 252 to 260 of the above-described embodiment. However, in this embodiment, a second fluid may be introduced to the fluid control system 50′ at step 312, as the controller 64 operates to open the valves 94 and 72 connecting the second fluid reservoir 84 and the waste reservoir 60 to the fluid control system 50′. Fluid from the second fluid reservoir 84 is allowed to flow through conduit 86, through the manifolded conduit 74, into the inlet 76, and through the inlet port 128 into the valve cavity 132. Such fluid then follows a path along the manifolded conduit 98 and through the conduit 62 into the waste reservoir 60. Fluid from the second fluid reservoir 84 flows for an assessed time interval at step 314, where the time interval may be measured, for example, to allow the fluid from the second fluid reservoir 84 to reach the waste reservoir 60.

In one embodiment, the second fluid reservoir 84 may be filled with a pressurized gas so as to clear the conduits of the fluid control system 50′ of any remaining ink or other fluids before a second ink is introduced to the system 50′. In such an embodiment, a release valve or port (not shown) may be located on or near the waste reservoir 60 to allow for dispersal of the pressurized gas from the system 50′, while maintaining a collection of fluids within the waste reservoir 60. In another embodiment, the first fluid reservoir 80 may be filled with a pressurized gas so as to clear the conduits of the fluid control system 50′ of any remaining ink or other fluids before a second fluid is introduced to the system 50′.

At step 316, when the desired transmission of from the second fluid reservoir 84 has occurred, the controller 64 operates to close the valves 94, shutting off connection to the second fluid reservoir 84. The valve 70 is opened at step 318 and ink from the second ink reservoir 56 is allowed to flow into the conduit 58, through the manifolded conduit 74, into the inlet 76, through the inlet port 128 and into the valve cavity 132 of the printhead mount 66. The ink from the second ink reservoir 56 flows for an assessed time interval at step 320, where the time interval may be measured, for example, to allow the ink from the second ink reservoir 56 to reach at least downstream of the valve 72. At step 322, the valve 72 is closed.

It is at step 324 that a printhead cartridge is inserted into the printhead mount 66, allowing fluid communication between the printhead mount 66 and a cartridge, as described previously. A printhead cartridge used in the method 300 is preferably also of the type described in the methods 200 and 250. After a printhead cartridge is installed, printing operations of the inkjet printing system are allowed to resume.

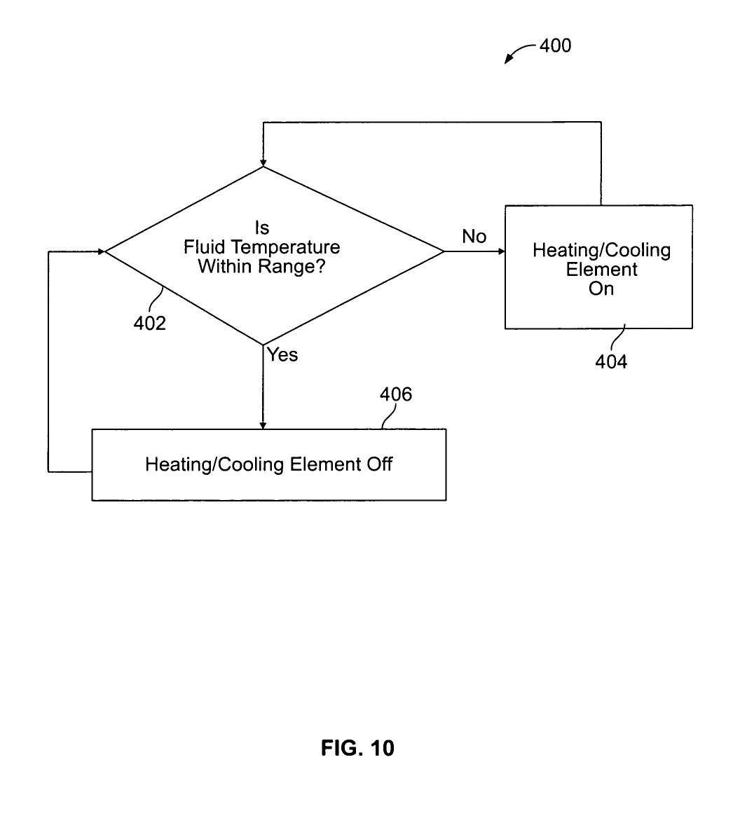

In FIG. 10, a method 400 is illustrated which describes the operation of temperature regulation elements utilized with an embodiment or embodiments of the fluid control systems 50 or 50′. At step 402, the controller 64 seeks input from the temperature sensor or sensors 142 (shown in FIGS. 6 and 7) to determine whether the temperature of the fluids adjacent the sensor or sensors 142 is at a predetermined value or within a predetermined range. If yes, the method 400 continues to step 406, as described below. However, if not, the method 400 continues to step 404 and the controller 64 acts to engage the temperature control element or elements 140 (also shown in FIGS. 6 and 7). This function acts to either warm or cool the fluid adjacent the temperature control element or elements 140 to a desired temperature. As the temperature control element or elements 140 are engaged, the method 400 returns to step 402 and again polls the temperature sensor or sensors 142. When the temperature reading received from the sensor or sensors 142 is at its predetermined value or within its predetermined range, or if the temperature received from the sensor or sensors 142 in step 402 was an acceptable temperature within the ideal range initially, the method 400 continues to step 406, where a signal or lack thereof is issued from the controller 64 to cause the temperature control element or elements 140 to be powered down. The method 400 may return to step 402 and again poll the sensor 142. Such temperature regulation method 400 may be associated with and inserted into the methods 200 or 250. In one embodiment, when the desired temperature of the fluids in the fluid control system 50 or 50′ is reached, a printhead cartridge may be inserted into the printhead mount 66, as was previously described above with regard to step 212 in the method 200 and step 320 in the method 250. The ability to maintain the apparatus of the fluid control system 50, 50′ within a desired temperature range during the flushing and/or cleaning process may allow the fluid control system 50, 50′ to be put into immediate use in a printing process without any delay that may otherwise be associated with bringing the apparatus to within the desired temperature range before printing may resume.

The method 400 may also stand alone from additional fluid control methods, with the controller 64 polling the temperature of fluid control system 50 or 50′ fluids and adjusting the temperature of such fluids accordingly. For example, in one embodiment, a printhead cartridge that is mounted within the printhead mount 66 during printing operations of an inkjet printing system may include a sensor within a cavity of the cartridge (not shown) to determine whether the temperature of ink flowing through the printhead cartridge is at a predetermined value or within a predetermined range. A temperature control element disposed within the printhead cartridge, within the printhead mount 66, or elsewhere within the fluid control system 50, 50′ may then be applied to adjust the temperature of the ink as described by the method 400 described hereinabove. In another embodiment, a sensor may be associated with a body of the printhead cartridge that is mounted within the printhead mount 66 during printing operations of an inkjet printing system, wherein the sensor provides a determination of the temperature of the body of the printhead cartridge as feedback for a temperature control element that is disposed within the fluid control system 50 or 50′, for example within the printhead mount 66.

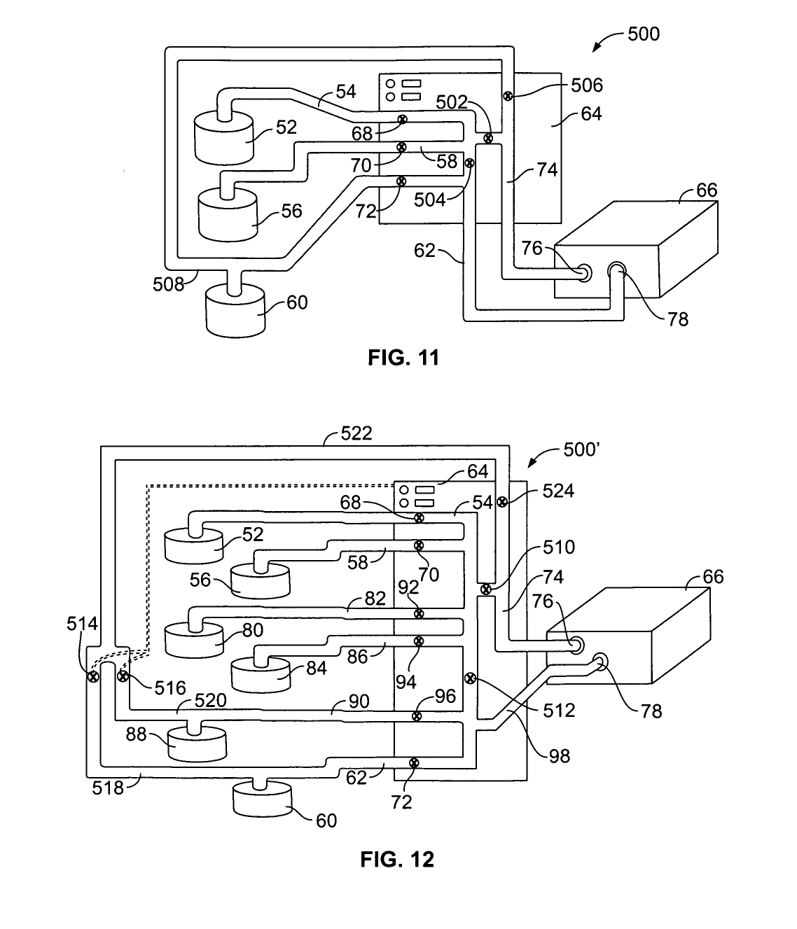

When ink remains stagnant for an extended period of time in a fluid transmission conduit of a fluid control system, for example the fluid control system 50 or 50′, the ink may degrade and/or thicken, which may cause problems in operation of the fluid control system. Another embodiment of a fluid control system 500, as illustrated in FIG. 11, facilitates prevention of the problems caused by ink stagnation by providing alternative modes of operation that prevent the ink from becoming stagnant. The fluid control system 500 is similar to the fluid control system 50 described in FIG. 1 hereinabove, but includes the following differences. A valve 502 is disposed at an inlet end of the fluid transmission conduit 74 adjacent a manifold that connects the fluid transmission conduits 54 and 58. Another valve 504 is disposed in a fluid transmission conduit that connects the fluid transmission conduit 62 to the manifold that connects the fluid transmission conduits 54 and 58. Yet another valve 506 is disposed in a fluid transmission conduit 508 that connects the fluid transmission conduit 74 to the waste reservoir 60.

The controller 64 is electrically connected to and controls operation of the valves 502, 504, and 506, which allow the fluid control system 500 to operate in two alternative modes. In a first mode of operation, the valve 502 is held open and the valves 504 and 506 are held closed and ink is supplied to the printhead mount 66 via the fluid transmission conduit 74 and the inlet 76. In this first mode of operation, the fluid control system 500 can perform the flushing method shown in FIG. 8 and hereinabove described with regard to the apparatus of the fluid control system 50 that is illustrated in FIG. 1.

In a second mode of operation, the valve 502 is held closed and the valve 504 is held open and ink is supplied to the printhead mount 66 via the fluid transmission conduit 62 and the outlet 78. The flushing method shown in FIG. 8 may also be performed by the fluid control system 500 when in the second mode of operation. Illustratively referring to FIG. 8, the step 206 may open the valves 70 and 506 in the second mode of operation. Further, the time lapse T1 in the step 208 is a predetermined time interval, for example, that may be sufficient to allow ink from the second ink reservoir 56 to flow through the fluid transmission conduits 62 and 74 to beyond the valve 506. Periodically alternating between the first and second modes of operation in this embodiment may prevent ink from stagnating in either of the fluid transmission conduits 62 or 74.

A further embodiment of a fluid control system 500′ is illustrated in FIG. 12 and is similar to the fluid control system 50′ described in FIG. 2 hereinabove, but includes the following differences. A valve 510 is disposed at an inlet end of the fluid transmission conduit 74 just downstream of a manifold that connects the fluid transmission conduits 54, 58, 82, and 86. Another valve 512 is disposed in a fluid transmission conduit that provides fluid communication between a manifold that connects the fluid transmission conduits 62 and 90 and the manifold that connects the fluid transmission conduits 54, 58, 82, and 86. Valves 514 and 516 connect fluid transmission conduits 518 and 520 connected to the waste reservoir 60 and the recycle reservoir 88, respectively, to a fluid transmission conduit 522 that provides fluid communication with the fluid transmission conduit 74 downstream of the valve 510 via a valve 524.

The controller 64 is electrically connected to and controls operation of the valves 510, 512, 514, 516, and 524, which allow the fluid control system 500′ to operate in two alternative modes. In a first mode of operation, the valve 510 is held open and the valves 512 and 524 are held closed and ink is supplied to the printhead mount 66 via the fluid transmission conduit 74 and the inlet 76. In this first mode of operation, the fluid control system 500′ can perform the flushing methods shown in FIGS. 9A and 9B and hereinabove described with regard to the apparatus of the fluid control system 50′ that is illustrated in FIG. 2.

In a second mode of operation, the valve 510 is held closed and the valve 512 is held open and ink is supplied to the printhead mount 66 via the fluid transmission conduit 98 and the outlet 78. The flushing methods shown in FIGS. 9A and 9B may be performed by the fluid control system 500′ when in the second mode of operation. Illustratively referring to FIG. 9A, the step 256 may open the valves 92, 516, and 524 in the second mode of operation. The time lapse T1 in the step 258 is a predetermined time interval, for example, that may be sufficient to allow fluid from the first fluid reservoir 80 to flow through the fluid transmission conduits 98, 74, and 522 to beyond the valve 516. The step 260 closes the valves 92 and 516 and the step 262 opens the valves 70 and 514. The time lapse T2 in the step 264 is a predetermined time interval, for example, that may be sufficient to allow ink from the second ink reservoir 56 to flow through the fluid transmission conduits 98, 74, and 522 to beyond the valve 514. The step 266 closes the valves 514 and 524.

Illustratively referring to FIG. 9B, the steps 302-310 are identical to the steps 252-260 of the method shown in FIG. 9A when flushing the fluid control system 500′ in the second mode of operation. The step 312 may open the valves 94, 514, and 524 in the second mode of operation. The time lapse T2 in the step 314 is a predetermined time interval, for example, that may be sufficient to allow fluid from the second fluid reservoir 84 to flow through the fluid transmission conduits 98, 74, and 522 to beyond the valve 514. The step 316 closes the valve 94 and the step 318 opens the valve 70. The time lapse T3 in the step 320 is a predetermined time interval, for example, that may be sufficient to allow ink from the second ink reservoir 56 to flow through the fluid transmission conduits 98, 74, and 522 to beyond the valve 514. The step 322 closes the valves 514 and 524. Periodically alternating between the first and second modes of operation in this embodiment may prevent ink from stagnating in either of the fluid transmission conduits 74 or 98.

The foregoing description of the disclosure discloses and describes merely exemplary embodiments of the present disclosure and is not intended to be exhaustive or to limit the disclosure to the precise form disclosed. As will be understood by those skilled in the art, the disclosure may be embodied in other specific forms, or modified or varied in light of the above teachings, without departing from the spirit, novelty or essential characteristics of the disclosure. Accordingly, the disclosure of the present disclosure is intended to be illustrative, but not limiting, of the scope of the disclosure, which is set forth in the following claims.

### INDUSTRIAL APPLICABILITY

A system and method for fluid transmission and temperature regulation in an inkjet printing system is presented. Ink supply to a printhead mount is turned off and one or more fluids are flushed through the printhead mount. The fluids may be collected for recycling or may be disposed of as waste. A temperature control system is incorporated into the printing system to maintain the temperature of the apparatus and fluid within the apparatus within a desired temperature range. The temperature control system may operate to maintain the temperature of the apparatus and fluid within the apparatus while fluids are flushed through the printhead mount and/or during operation of the inkjet printing system. Further, ink and flush fluids may be supplied to the printhead mount in multiple modes of operation to facilitate prevention of ink stagnation within the apparatus.

Numerous modifications to the present invention will be apparent to those skilled in the art in view of the foregoing description. Accordingly, this description is to be construed as illustrative only and is presented for the purpose of enabling those skilled in the art to make and use the invention and to teach the best mode of carrying out same. The exclusive rights to all modifications which come within the scope of the appended claims are reserved. All patents, patent publications and applications, and other references cited herein are incorporated by reference herein in their entirety.

We claim:

1. A system for fluid transmission and temperature regulation in an inkjet printing system, comprising:
first and second ink supplies connected via respective first and second valves to a fluid supply conduit;
a printhead mount adapted to hold a printhead cartridge and including an inlet port connected to the fluid supply conduit and an outlet port connected via a fluid transmission conduit and a third valve to a waste reservoir; and
a controller connected to each of the first, second, and third valves.

2. The system of claim 1 further comprising:
a temperature control element and a temperature sensor, each disposed downstream of the first and second valves; and
the controller connected to the temperature control element and the temperature sensor.

3. The system of claim 2, wherein the temperature control element and the temperature sensor are associated with a valve cavity within the printhead mount.

4. The system of claim 2, wherein the temperature control element and the temperature sensor are disposed in series in the ink supply manifold.

5. The system of claim 1 further comprising:
first and second fluid supplies connected via respective fourth and fifth valves to the fluid supply manifold;
a recycle reservoir connected via a sixth valve to the fluid transmission conduit; and
the controller connected to each of the fourth, fifth, and sixth valves.

6. The system of claim 5, wherein each of the fluids in the first and second fluid supplies is a fluid selected from the group consisting of air, helium, argon, nitrogen, oxygen, water, solvents, surfactants, water-displacing agents, humectants, and combinations thereof.

7. The system of claim 6 further comprising:
a temperature control element and a temperature sensor, each disposed downstream of the first, second, fourth, and fifth valves; and
the controller connected to the temperature control element and the temperature sensor.

8. The system of claim 7, wherein the temperature control element and the temperature sensor are associated with a valve cavity within the printhead mount.

9. The system of claim 8, wherein the temperature control element and the temperature sensor are disposed in series in the fluid supply manifold.

10. A method for fluid transmission and temperature regulation in an inkjet printing system that includes a printhead mount that is adapted to hold a printhead cartridge and further includes an inlet port connected to a fluid supply conduit that is supplied by first and second ink supplies connected via respective first and second valves to the fluid supply conduit and an outlet port connected via a fluid transmission conduit and a third valve to a waste reservoir, comprising the steps of:
removing a first printhead cartridge from the printhead mount;
closing the first valve;
opening the third valve;
opening the second valve;
allowing a first predetermined time period to pass, wherein the first predetermined time period is sufficient to allow ink from the second ink supply to flow beyond the third valve;
closing the third valve; and
inserting a second printhead cartridge into the printhead mount.

11. The method of claim 10 further including the following step between the steps of opening the second valve and allowing the first predetermined time period to pass:
comparing a measured temperature from a temperature sensor to a predetermined temperature range and, if necessary, activating a temperature control element to correct the measured temperature; and
wherein the step of closing the third valve comprises closing the third valve when both the first predetermined time period has passed and the measured temperature is within the predetermined temperature range.

12. The method of claim 10 for fluid transmission and temperature regulation in an inkjet printing system that further includes a first fluid supply connected via a fourth valve to the fluid supply conduit and a recycle reservoir connected via a fifth valve to the fluid transmission conduit, and further including the following steps between the steps of closing the first valve and opening the third valve:
opening the fifth valve;
opening the fourth valve;
allowing a second predetermined time period to pass, wherein the second predetermined time period is sufficient to allow fluid from the first fluid supply to flow beyond the fifth valve;
closing the fifth valve; and
closing the fourth valve.

13. The method of claim 12 further including the following step between the steps of opening the second valve and allowing the first predetermined time period to pass:
comparing a measured temperature from a temperature sensor to a predetermined temperature range and, if necessary, activating a temperature control element to correct the measured temperature; and
wherein the step of closing the third valve comprises closing the third valve when both the first predetermined time period has passed and the measured temperature is within the predetermined temperature range.

14. The method of claim 12 for fluid transmission and temperature regulation in an inkjet printing system that further includes a second fluid supply connected via a sixth valve to the fluid supply conduit, and further including the following steps between the steps of opening the third valve and opening the second valve:
opening the sixth valve;
allowing a third predetermined time period to pass, wherein the third predetermined time period is sufficient to allow fluid from the second fluid supply to flow beyond the third valve; and
closing the sixth valve.

15. The method of claim 14 further including the following step between the steps of opening the second valve and allowing the first predetermined time period to pass:
comparing a measured temperature from a temperature sensor to a predetermined temperature range and, if necessary, activating a temperature control element to correct the measured temperature; and
wherein the step of closing the third valve comprises closing the third valve when both the first predetermined time period has passed and the measured temperature is within the predetermined temperature range.

16. The method of claim 15, wherein each of the fluids in the first and second fluid supplies is a fluid selected from the group consisting of air, helium, argon, nitrogen, oxygen, water, solvents, surfactants, water-displacing agents, humectants, and combinations thereof.

17. A system for fluid transmission and temperature regulation in an inkjet printing system, comprising:
first and second ink supplies connected via respective first and second valves to an inlet end of a fluid supply conduit;
a printhead mount including an inlet port connected to an outlet end of the fluid supply conduit and an outlet port connected via a first fluid transmission conduit and a third valve to a waste reservoir;
a printhead cartridge mounted within the printhead mount and in fluid communication with the inlet and outlet ports of the printhead mount;
a temperature control element and a temperature sensor, each disposed downstream of the first and second valves; and
a controller connected to the temperature control element, the temperature sensor, and to each of the first, second, and third valves.

18. The system of claim 17 further comprising:
a fourth valve disposed at the inlet end of the fluid supply conduit;
a second fluid transmission conduit that provides fluid communication between the first and second ink supplies and the first fluid transmission conduit;
a fifth valve disposed in the second fluid transmission conduit; and
a sixth valve in a third fluid transmission conduit that provides fluid communication between the fluid supply conduit and the waste reservoir, wherein the controller is connected to the fourth, fifth, and sixth valves.

19. The system of claim 17 further comprising:
first and second fluid supplies connected via respective fourth and fifth valves to the fluid supply manifold;
a recycle reservoir connected via a sixth valve to the first fluid transmission conduit; and
the controller connected to each of the fourth, fifth, and sixth valves.

20. The system of claim 19, wherein the temperature sensor is disposed within the printhead cartridge.

21. The system of claim 19, wherein each of the fluids in the first and second fluid supplies is a fluid selected from the group consisting of air, helium, argon, nitrogen, oxygen, water, solvents, surfactants, water-displacing agents, humectants, and combinations thereof.

22. The system of claim 19 further comprising:
a seventh valve disposed at the inlet end of the fluid supply conduit;
a second fluid transmission conduit that provides fluid communication between the first, second, fourth, and fifth valves and the first fluid transmission conduit;
an eighth valve disposed in the second fluid transmission conduit; and
a ninth valve in a third fluid transmission conduit that provides fluid communication between the fluid supply conduit and the recycle reservoir via a tenth valve and the waste reservoir via an eleventh valve, wherein the controller is connected to the seventh, eighth, ninth, tenth, and eleventh valves.

23. The system of claim 22, wherein the temperature sensor is disposed within the printhead cartridge.

24. The system of claim 22, wherein each of the fluids in the first and second fluid supplies is a fluid selected from the group consisting of air, helium, argon, nitrogen, oxygen, water, solvents, surfactants, water-displacing agents, humectants, and combinations thereof.

25. A method for fluid transmission and temperature regulation in an inkjet printing system including a first printhead cartridge mounted within a printhead mount and in fluid communication with inlet and outlet ports of the printhead mount, wherein the inlet port is connected to an outlet end of a fluid supply conduit that is supplied by first and second ink supplies connected via respective first and second valves to an inlet end of the fluid supply conduit and wherein the outlet port is connected via a first fluid transmission conduit and a third valve to a waste reservoir, comprising the steps of:
removing the first printhead cartridge from the printhead mount;
closing the first valve;
opening the third valve;
opening the second valve;
allowing a first predetermined time period to pass, wherein the first predetermined time period is sufficient to allow ink from the second ink supply to flow beyond the third valve;
closing the third valve;
inserting a second printhead cartridge into the printhead mount;
operating the inkjet printing system with the ink from the second ink supply;
determining a temperature of the ink from the second ink supply from a temperature sensor disposed within the second printhead cartridge; and
comparing the temperature of the ink from the second ink supply to a first predetermined temperature range and, if necessary, activating a temperature control element disposed upstream of the temperature sensor disposed within the second printhead cartridge to correct the temperature of the ink from the second ink supply to within the first predetermined temperature range.

26. The method for fluid transmission and temperature regulation in the inkjet printing system of claim 25 that further includes a fourth valve disposed at the inlet end of the fluid supply conduit, a fifth valve disposed in a second fluid transmission conduit that provides fluid communication between the first and second ink supplies and the first fluid transmission conduit, and a sixth valve in a third fluid transmission conduit that provides fluid communication between the fluid supply conduit and the waste reservoir, and further including the following steps after the last step of claim 25:
removing the second printhead cartridge from the printhead mount;
closing the fourth valve;
closing the second valve;
opening the sixth valve;
opening the fifth valve;
opening the first valve;
allowing a second predetermined time period to pass, wherein the second predetermined time period is sufficient to allow ink from the first ink supply to flow beyond the sixth valve;
closing the sixth valve;
inserting a third printhead cartridge into the printhead mount;
operating the inkjet printing system with the ink from the first ink supply;
determining a temperature of the ink from the first ink supply from a temperature sensor disposed within the third printhead cartridge; and
comparing the temperature of the ink from the first ink supply to a second predetermined temperature range and, if necessary, activating the temperature control element disposed upstream of the temperature sensor disposed within the third printhead cartridge to correct the temperature of the ink from the second ink supply to within the second predetermined temperature range.

27. The method for fluid transmission and temperature regulation in the inkjet printing system of claim 25 that further includes a first fluid supply connected via a fourth valve to the fluid supply conduit and a recycle reservoir connected via a fifth valve to the first fluid transmission conduit, and further including the following steps between the steps of closing the first valve and opening the third valve:
opening the fifth valve;
opening the fourth valve;
allowing a second predetermined time period to pass, wherein the second predetermined time period is sufficient to allow fluid from the first fluid supply to flow beyond the fifth valve;
closing the fifth valve; and
closing the fourth valve.

28. The method for fluid transmission and temperature regulation in the inkjet printing system of claim 27 that further includes a sixth valve disposed at the inlet end of the fluid supply conduit, a seventh valve disposed in a second fluid transmission conduit that provides fluid communication between the first, second, and fourth valves and the first fluid transmission conduit, and an eighth valve in a third fluid transmission conduit that provides fluid communication between the fluid supply conduit and the recycle reservoir via a ninth valve and the waste reservoir via a tenth valve, and further including the following steps after the last step of claim 27:
removing the second printhead cartridge from the printhead mount;
closing the sixth valve;
closing the second valve;
opening the ninth valve;
opening the eighth valve;
opening the seventh valve;
opening the fourth valve;
allowing a third predetermined time period to pass, wherein the third predetermined time period is sufficient to allow fluid from the first fluid supply to flow beyond the ninth valve;
closing the ninth valve;
closing the fourth valve;
opening the tenth valve;
opening the first valve;
allowing a fourth predetermined time period to pass, wherein the fourth predetermined time period is sufficient to allow ink from the first ink supply to flow beyond the tenth valve;
closing the tenth valve;
inserting a third printhead cartridge into the printhead mount;
operating the inkjet printing system with the ink from the first ink supply;
determining a temperature of the ink from the first ink supply from a temperature sensor disposed within the third printhead cartridge; and
comparing the temperature of the ink from the first ink supply to a second predetermined temperature range and, if necessary, activating the temperature control element disposed upstream of the temperature sensor disposed within the third printhead cartridge to correct the temperature of the ink from the first ink supply to within the second predetermined temperature range.

29. The method for fluid transmission and temperature regulation in the inkjet printing system of claim 27 that further includes a second fluid supply connected via a sixth valve to the fluid supply conduit, and further including the following steps between the steps of opening the third valve and opening the second valve:
opening the sixth valve;
allowing a third predetermined time period to pass, wherein the third predetermined time period is sufficient to allow fluid from the second fluid supply to flow beyond the third valve; and
closing the sixth valve.

30. The method for fluid transmission and temperature regulation in the inkjet printing system of claim 29, wherein each of the fluids in the first and second fluid supplies is a fluid selected from the group consisting of air, helium, argon, nitrogen, oxygen, water, solvents, surfactants, water-displacing agents, humectants, and combinations thereof.

31. The method for fluid transmission and temperature regulation in the inkjet printing system of claim 29 that further includes a seventh valve disposed at the inlet end of the fluid supply conduit, an eighth valve disposed in a second fluid transmission conduit that provides fluid communication between the first, second, fourth, and sixth valves and the first fluid transmission conduit, and a ninth valve in a third fluid transmission conduit that provides fluid communication between the fluid supply conduit and the recycle reservoir via a tenth valve and the waste reservoir via an eleventh valve, and further including the following steps after the last step of claim 29:
removing the second printhead cartridge from the printhead mount;
closing the seventh valve;
closing the second valve;
opening the tenth valve;
opening the ninth valve;
opening the eighth valve;
opening the fourth valve;
allowing a fourth predetermined time period to pass, wherein the fourth predetermined time period is sufficient to allow fluid from the first fluid supply to flow beyond the tenth valve;
closing the tenth valve;
closing the fourth valve;
opening the eleventh valve;
opening the sixth valve;
allowing a fifth predetermined time period to pass, wherein the fifth predetermined time period is sufficient to allow fluid from the second fluid supply to flow beyond the eleventh valve;
closing the sixth valve;
opening the first valve;
allowing a sixth predetermined time period to pass, wherein the sixth predetermined time period is sufficient to allow ink from the first ink supply to flow beyond the eleventh valve;
closing the eleventh valve;
inserting a third printhead cartridge into the printhead mount;
operating the inkjet printing system with the ink from the first ink supply;
determining a temperature of the ink from the first ink supply from a temperature sensor disposed within the third printhead cartridge; and
comparing the temperature of the ink from the first ink supply to a second predetermined temperature range and, if necessary, activating the temperature control element disposed upstream of the temperature sensor disposed within the third printhead cartridge to correct the temperature of the ink from the first ink supply to within the second predetermined temperature range.
